(19) United States
(12) Patent Application Publication
(10) Pub. No.: US 2003/0174968 A1
(43) Pub. Date: Sep. 18, 2003

(54) Self-aligned optical coupler

(76) Inventors: Keith Kang, Hollis, NH (US); Greg Dudoff, Amherst, NH (US); Tom Faska, Brookline, NH (US); John Trezza, Nashua, NH (US)

Correspondence Address: MORGAN & FINNEGAN, L.L.P., 345 Park Avenue, New York, NY, 10154-0053, US

(21) Appl. No.: 10/389,343

(22) Filed: Mar. 14, 2003

Related U.S. Application Data
(60) Provisional application No. 60/365,699, filed on Mar. 18, 2002.

(51) Int. Cl. G02B 6/26

(52) U.S. Cl. 385/52

(57) ABSTRACT

A method of ensuring proper alignment between one optical device bearing unit and another optical device bearing unit involves creating a set of precisely placed and sized features for the one optical device bearing unit, creating a set of precisely placed and sized features for the other optical device bearing unit, the features being of a complementary pattern to enable the optical device bearing units to mate such that they are properly aligned with each other. An optical device unit is also described. The unit has multiple optical components, and a set of features sized and positioned to mate with complementary features of a different optical device unit so that when the units are brought together, the set of features and complementary features will ensure that the units are properly aligned with respect to each other.

### CROSS REFERENCE TO RELATED APPLICATIONS

This application claims priority under 35 USC 119(e)(1) of U.S. Provisional Patent Application Serial No. 60/365,699 filed Mar. 18, 2002.

### FIELD OF THE INVENTION

This invention relates to optical elements and, more particularly to optical elements used in conjunction with arrays of lasers and/or detectors.

### BACKGROUND

Lens arrays and other optical elements are useful and, in many cases necessary, to ensure proper operation of an array of semiconductor optical devices (i.e. lasers, detectors, modulators, etc.). Presently, optical elements, for example microlenses, are typically held by separate fixtures. In order to be used, they must be properly aligned in the plane of the devices (the x-y plane) and properly spaced in the direction of light travel (the z-direction). In addition, inaccuracies due to a slight rotation about one of those axes (typically called “roll” (R), “pitch” (P) and “yaw” (Y)) can detrimentally affect operation of the optical devices, even if the optical elements are aligned in the x, y, and z directions. As a result, obtaining proper x, y, z, R, P and Y alignment is a time consuming, but critical, process that disproportionately increases cost due to its labor intensive iterative nature.

The above problem has impeded the use of such optical elements in conjunction with large arrays of these small optical devices.

Papers have described the use of microlenses in conjunction with arrays of optical devices by creating microlenses directly on the back of the optical device wafers so that the lenses are etched directly into the wafer material. However, with such an approach, it is difficult to control lens performance and it significantly risks damaging the optical devices during the lens creation processing.

Thus, there is a need in the art for a way to use optical elements in conjunction with optical devices such as lasers, detectors, modulators, etc. that does not suffer from the above problems.

### SUMMARY OF THE INVENTION

We have devised a way to integrate multiple optical elements, whether refractive or diffractive optical devices, for example, arrays of microlenses, collimators, waveguides, micromirrors, etc. with optical devices such as lasers, detectors, modulators, etc. that avoids the problems of the prior art.

In accordance with our invention, such optical elements and devices can be readily integrated together for use in anything from small arrays of optical elements to massively parallel arrays of such optical devices or for arrays of single wavelength optical devices or single arrays of multiple wavelength devices.

One aspect of the invention involves a method of ensuring proper alignment between one optical device bearing unit and another optical device bearing unit involves creating a set of precise features for the one optical device bearing unit, creating a set of precise features for the other optical device bearing unit, the features being of a complementary pattern to enable the optical device bearing units to mate such that they are properly aligned with each other.

Another aspect of the invention involves an optical device unit. The unit has multiple optical components, and a set of features sized and positioned to mate with complementary features of a different optical device unit so that when the units are brought together, the set of features and complementary features will ensure that the units are properly aligned with respect to each other.

By employing the teachings of the invention, a number of advantages can be achieved. For example, by employing the teachings of the invention, obtaining accurate alignment between the elements and devices becomes simpler and repeatable without meaningful loss of precision (i.e. within acceptable tolerances). Alignment is automatic, so integration of the elements and devices can be readily automated. The optical active (i.e. lasers, detectors, etc.) and passive (i.e. lenses, collimators, waveguides, etc.) components can be independently optimized and then combined together. The risk of damaging the active components during integration is reduced. Components can become “parts bin” interchangeable and/or “touch labor” on the optical devices and elements is reduced.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 is an example active optical device bearing unit made in accordance with the invention;

FIG. 2 is an example of another variant of an active optical device bearing unit made in accordance with the teachings of the invention;

FIG. 3 is a perspective view of an example passive optical element unit made in accordance with the invention;

FIG. 4 is a simplified perspective view of the underside of another example passive optical element unit in accordance with the invention;

FIG. 5 is a side view of the unit of FIG. 2 and a microlens array made in accordance with the invention via an etching process;

FIG. 6 shows the units of FIG. 5 after they have been brought together;

FIG. 7 is an example of an optical transceiver made according to the teachings of the invention;

FIG. 8 are portions of different passive device units according to the invention;

FIG. 9 is an example of another alternative variant of an active device array made in accordance with the invention; and

FIG. 10 is an example of yet another alternative variant of an active device array made in accordance with the invention.

### DETAILED DESCRIPTION

We have created a way to integrate passive optical elements, such as lenses, collimators, waveguides with an active optical device array, whether of one optical device type or of multiple device types. Our approach makes it possible to form elements to focus light onto fibers or to combine the light from/to many optical devices/fibers. Thus, it has applicability to diverse applications such as telecommunications, computer networks, optical switching and connection devices on a small through massively parallel scale and/or in connection single and/or multiple-wavelength optical components.

In overview, we utilize a set of features, common to both the optical device bearing unit and the optical elements, that have been accurately placed and dimensioned to ensure proper alignment, in the x, y, z, R, P and Y directions, between the optical elements and the optical devices.

In accordance with the teachings of the invention, we integrate passive optical elements with active optical elements by using precisely located and/or formed mating features on each. The proportions of these features can be controlled, if necessary, to sub micron accuracy, to ensure the two units mate with the elements aligned in the x, y, z, R, P and Y directions.

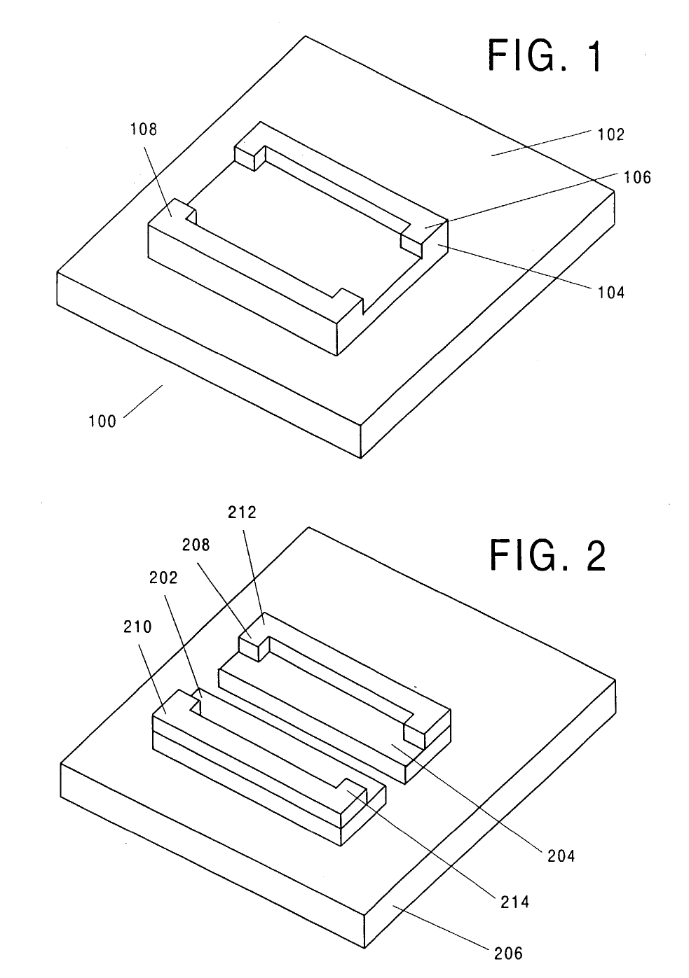

FIG. 1 is an example active optical device bearing unit 100 made in accordance with the invention. An electronic chip 102 is bonded to an array of active devices (e.g. lasers and/or detectors) that, in this example, are of the type that emit/receive through a, typically gallium arsenide, substrate 104 (i.e. they are “bottom” or “backside” emitting/receiving devices), although top emitting/receiving or some combination of the two could be used as well. A series of three dimensional features 106, 108, for example posts and grooves, are precision formed in the substrate 104, for example, using the well known high precision lithography techniques of patterning and etching. In this way the features 106, 108 can be formed with minimal to no risk of damaging the active optical devices themselves. The features 106, 108 are made to preestablish placement of a passive element relative to the active elements. By controlling the size and placement of the feature locations in the x-y direction, the passive elements that will mate with it will be properly located and constrained in the x, y and Y directions. By controlling the height and height uniformity, the passive elements will also be accurately be placed and constrained in the z, R and P directions. Although not required, the features will ideally be made so as to only allow mating one way to prevent attachment 180 degrees out of proper placement in the x-y plane.

FIG. 2 is an example of another variant of an active optical device bearing unit 200 made in accordance with the teachings of the invention. In this example, two separate arrays of active devices 202, 204 are integrated with an electronic integrated circuit (IC) 206. In the example of FIG. 2, the active devices do not emit/receive light from the backside (i.e. they are “top” emitting/receiving devices), although top emitting/receiving or some combination of the two could be used as well. As a result, additional material 208, 210 has been deposited on top of the devices 202, 204 so that features 212, 214 can be created without risk of damage to the active devices.

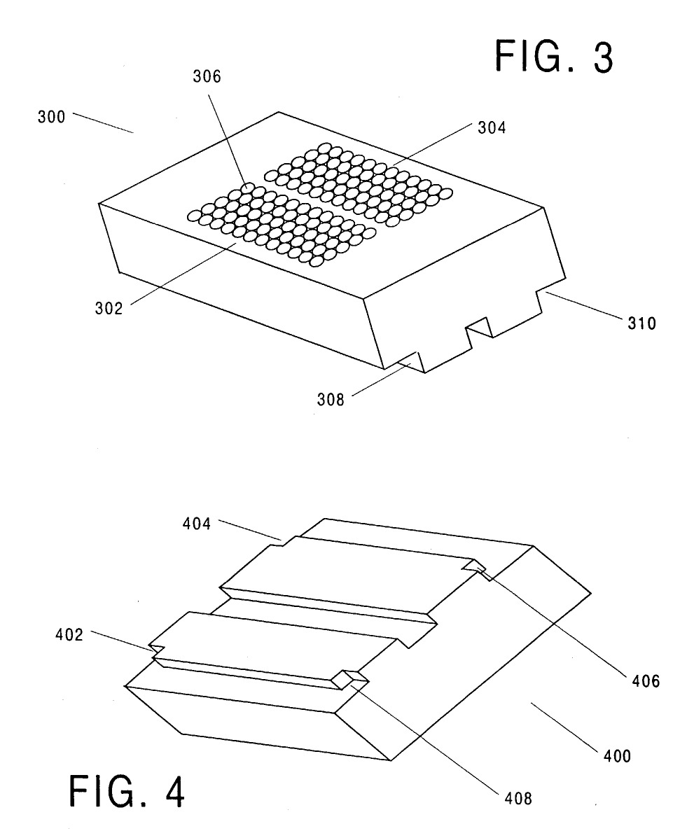

FIG. 3 is a perspective view of an example passive optical element unit 300 made in accordance with the invention. In this example, the optical elements 302, 304 are arrays of individual microlenses 306. Precisely placed features 308, 310 are formed on at least one side of the unit 300 that Vocationally correspond with, but are functionally the complement of, the features on an active device unit to which it will mate, for example, the unit 100 of FIG. 1. The features on this unit 300 are precision formed in a manner similar to that used for the active device bearing unit 100.

FIG. 4 is a simplified perspective view of the underside of another example passive optical element unit 400 in accordance with the invention. As shown, the unit 400 has features 402, 404, 406, 408 complementary to those for the active element units of FIG. 1 and FIG. 2. As noted above, by precisely controlling the location and depth of the features as well as the consistency of height and/or depth of those features across the unit 400, when this unit is attached to an active element unit, for example the active element units of FIG. 1 and FIG. 2, the pieces will be in alignment.

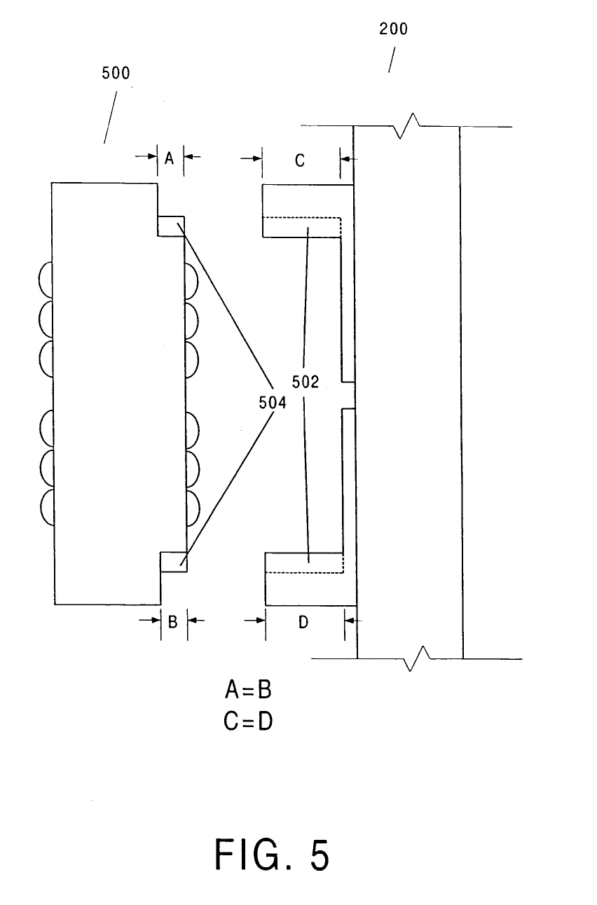

FIG. 5 is a side view of the unit 200 of FIG. 2 and a microlens array 500 made in accordance with the invention via an etching process. As can be seen, complementary features 502, 504 on each ensure that the two pieces are able to interlock in such a way that when placed together, the two pieces are automatically aligned with sufficient tolerance to work well. Thus, active and passive device bearing units can be aligned in a passive fashion during a simple assembly step. The features align the pieces in the x and y directions as well as x-y plane rotation. In addition, by controlling the flatness of the etching process, the height of the features and the thickness of the additional material, automatic placement in the z direction as well as in the other rotational directions are achieved automatically. In other words, by ensuring that the feature depths across one unit 500, labeled “A” and “B”, are the same and the feature heights on the other unit 200, labeled “C” and “D”, are the same, rotational alignment about the x, y and z axes (the R, P and Y) will also be proper. Thus, both units 500, 200 can be manufactured independently with a high degree of confidence that they will work together. In addition, if the features are standardized, the passive component unit 500 can become a “parts bin” component that can be mated in proper alignment with any complementary piece. Thus, based upon the fact they have identical features, assuming the active elements line up, the unit 500 of FIG. 5 could also readily be used with the unit 100 of FIG. 1.

Moreover, by using several different features on the same active device unit, different passive device units can be used and interchanged without any need for realignment.

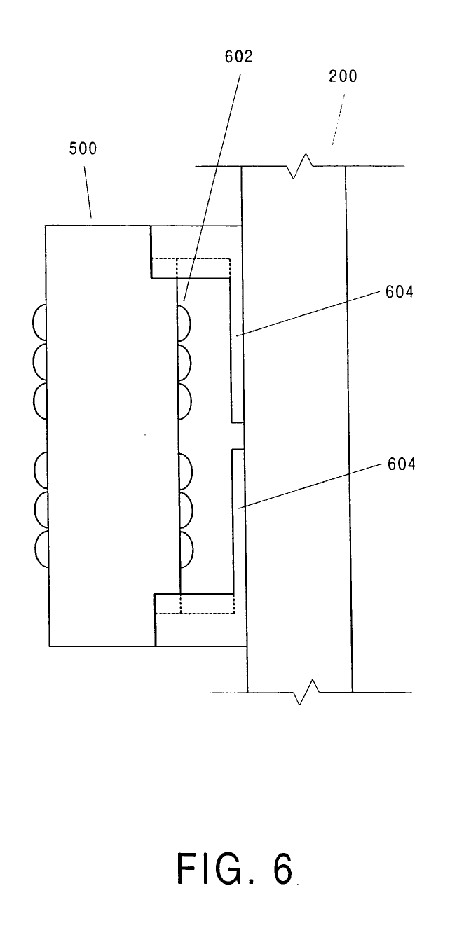

FIG. 6 shows the units 500, 200 of FIG. 5 after they have been brought together. Note that the microlens array 602 on the bottom of the passive unit 500 is perfectly spaced from the emitting receiving surface 604 of the active device unit 200. Moreover, by making the units in this manner, there is little risk of the microlens array 602 impacting, and possibly damaging, the active devices because the features act as depth stops.

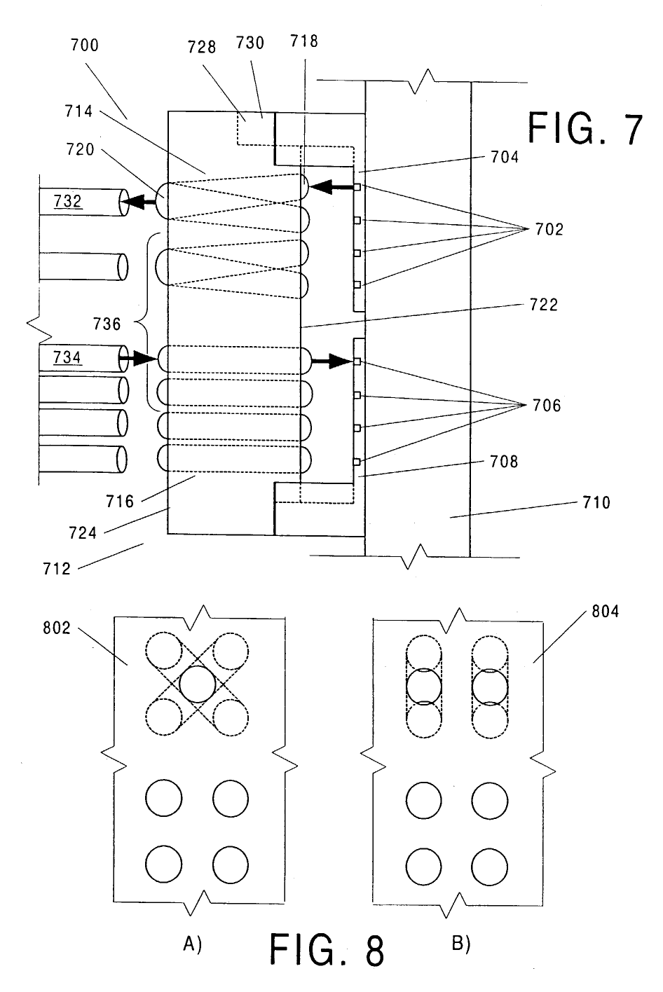

FIG. 7 is an example of an optical transceiver made according to the teachings of the invention. The transceiver 700 is made up of an array of bottom emitting lasers 702 that were formed on one wafer 704 and a separate array of detectors 706 that were formed on another wafer 708. The arrays 702, 706 are attached to a common electronic IC 710. As configured, the laser array 702 includes a number of redundant lasers so that, if one laser fails, another can be switched in its place without removal or disassembly of the transceiver 700. The transceiver 700 also includes a passive optical device unit 712. In this example, the passive optical device unit 712 includes waveguides 714 over the lasers 702 and collimators 716 over the detectors 706. A series of lenses 718, 720, are present on both sides 722, 724 of the unit 712 with the waveguides 714 connecting the lenses 718 over the lasers 702 with the lenses 720 on the other side 724 of the unit 712. Similarly, the collimators 716 connect the lenses 718 over the detectors 706 with the lenses 720 on the other side 724. A key way 728 or chamfer in the unit 712 is set up to mate with a corresponding post 730 on the active device unit 710 to ensure that the two units 710, 712 can only be joined one way. In operation, light from one laser 702 enters a waveguide 714 and is directed into an optical fiber 732 over its lenses 718, 720. Similarly, a detector 706 receives light from an optical fiber 734 via the collimator 716.

FIGS. 8A and 8B are each portions 802, 804 of the different passive device units according to the invention. Advantageously, both the passive device unit containing the portion 802 of FIG. 8A and the passive device unit containing the portion 804 of FIG. 8B have been made to be interchangeable. Thus, if the two portions 802, 804 corresponded to a portion 736 of FIG. 7, merely by substituting the unlit containing the portion 802 of FIG. 8A for a unit containing the portion 804 of FIG. 8B, a single transceiver could be configured from one that couples a pair of lasers to a common fiber to one that couples four lasers to a common fiber. As a result, the same passive device unit could be used in a myriad of ways. For example, for the arrangement of FIG. 8A, four different wavelength lasers could be coupled to a common fiber, two different wavelength lasers, each having a backup, could be coupled to a common fiber, or a single laser could even have three backups. Analogous, but fewer, combinations are possible with the arrangement of FIG. 8B.

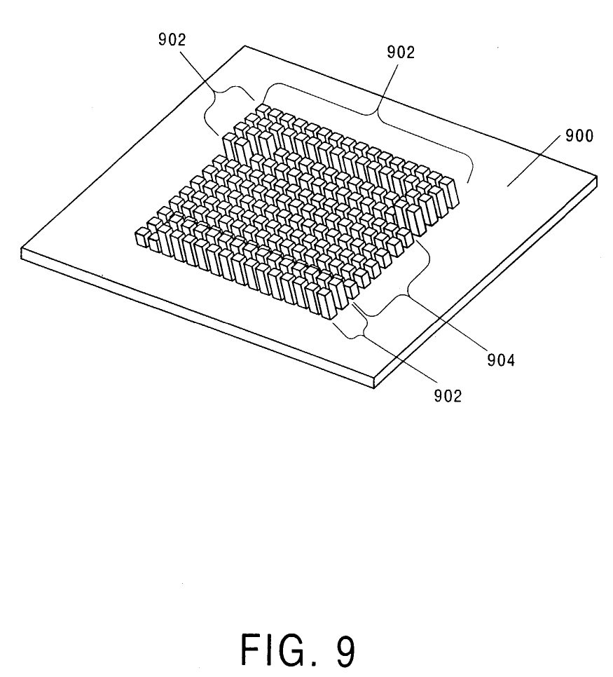

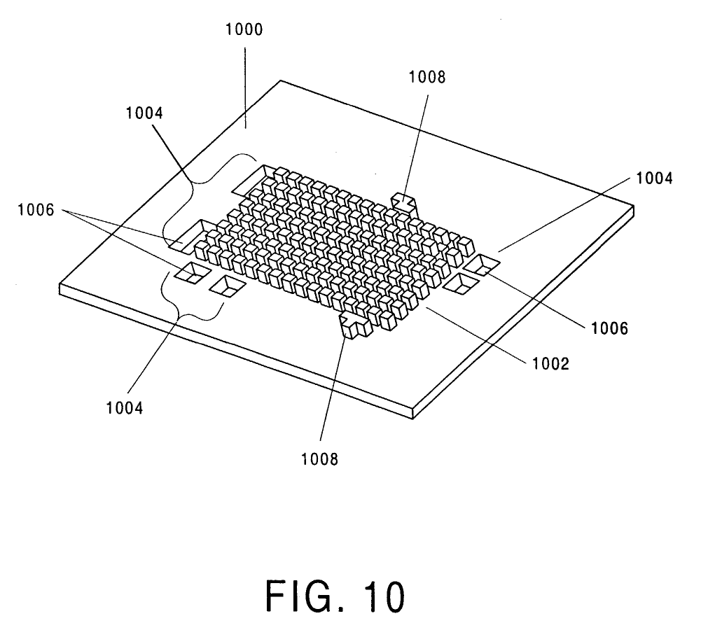

FIG. 9 is an example of another alternative variant of an active device array 908 made in accordance with the invention. In the arrangement of FIG. 9, the active devices are all top emitting devices, so there is no substrate on top of the devices in which to form the features and no material has been added on top of the lasers. Instead, the features are made on material 902 deposited on the wafer around the periphery of the devices 904. Alternatively, the features could be devices and/or extra material from the wafer processed to have different heights.

FIG. 10 is an example of yet another alternative variant of an active device array 1000 made in accordance with the invention. As with the arrangement of FIG. 9, the active devices 1002 are all top emitting/receiving devices, so there is no substrate on top of the devices 1002 in which to form the features and no material has been added on top of the active lasers. However, in this variant, the features 1004 are all precision cavities 1006 and bumps 1008 about the periphery of the devices 1002 that will mate with posts on a passive device unit (not shown).

Having described a number of different examples of variants incorporating the invention, it is important to note that in some variants, laser and detector wafer pieces containing the arrays need not be contiguous pieces. These optical pieces can be etched into individual devices if desired, for example, for electrical isolation between the devices. In such cases however, at least some of the original wafer substrate or some other material deposited on or adjacent to the devices would have to be present in order to provide the material that would carry the alignment features.

Moreover, depending upon the particular application, the arrays of devices can be integrated onto electronic integrated circuits (ICs), such as shown in FIG. 1, or they can be standalone arrays (i.e. without being integrated onto an integrated circuit).

Finally, while the invention has been described with reference to the features being typically formed through a patterning and etching process, if higher accuracy in feature size is required or, due to process variations, feature size across a wafer can not be controlled, for example due to the size of the wafer, the feature size can readily be optimized by one of the processes described in the commonly assigned United Stares Patent Application entitled “Post formation Feature Optimization”, filed Mar. 14, 2002, and incorporated herein in its entirety by reference.

In addition, while the invention has been illustrated and described in connection with aligning passive optical devices with active optical devices, a similar approach can be used for mating two separate passive optical device units together or two active device units together if the two would otherwise need to be aligned in a maimer similar to that used for aligning a passive device unit with an active device unit. Furthermore, it is to be understood that while described as having both lasers as detectors the active device unit could have all lasers, all detectors or same combination of lasers and detectors.

It should be understood that the above description is only representative of illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments incorporate the same principles of the invention and others are equivalent.

What is claimed is:

1. A method of ensuring proper alignment between a first optical device bearing unit and a second optical device bearing unit, the method comprising:
creating a first set of precisely placed and sized features for the first optical device bearing unit;
creating a second set of precisely placed and sized features for the second optical device bearing unit;
the first set of features and the second set of features being of a complementary pattern to enable the first optical device bearing unit to mate with the second optical device bearing unit such that they are properly aligned with each other.

2. The method of claim 1 wherein the first optical device bearing unit is an active device bearing unit, the method further comprising:
etching the features on a substrate of the active device bearing unit.

3. The method of claim 1 wherein the first optical device bearing unit is an active device bearing unit, the method further comprising:
depositing a material on the active device bearing unit; and
etching the features on the material.

4. The method of claim 1 wherein the first optical device bearing unit is a passive device bearing unit, the method further comprising:
etching the features on the passive device bearing unit.

5. The method of claim 1 wherein the creating the first set of precisely placed and sized features comprises:
forming posts on the first optical device bearing unit.

6. The method of claim 1 wherein the creating the first set of precisely placed and sized features comprises:
forming cavities in the first optical device bearing unit.

7. The method of claim 1 further comprising:
optimizing at least one feature of the first set of precisely placed and sized features.

8. The method of claim 7 wherein the optimizing comprises one of:
oxidizing or plating the at least one feature.

9. An optical device unit comprising:
multiple optical components, and
a set of features sized and positioned to mate with complementary features of a different optical device unit so that when the optical device unit and the different optical device unit are brought together, the set of features and complementary features will ensure that the optical device unit and the different optical device unit are properly aligned with respect to each other.

10. The optical device unit of claim 9 wherein at least some of the features are holes and the complementary features, for the holes, of the different optical device unit are posts.

11. The optical device unit of claim 9 wherein the multiple optical components comprise active optical components.

12. The optical device unit of claim 11 wherein the active optical components comprise:
semiconductor lasers.

13. The optical device unit of claim 11 wherein the active optical components comprise:
photodetectors.

14. The optical device unit of claim 11 wherein the active optical components comprise:
multiple semiconductor lasers and multiple photodetectors.

15. The optical device unit of claim 9 wherein the multiple optical components comprise passive optical components.

16. The optical device unit of claim 15 wherein the passive optical components comprise:
lenses.

17. The optical device unit of claim 15 wherein the passive optical components comprise:
waveguides.

18. The optical device unit of claim 15 wherein the passive optical components comprise:
modulators.

19. The optical device unit of claim 15 wherein the passive optical components comprise:
at least two different passive elements.

20. A method comprising:
creating the optical device unit of one of claims 9 through 19.
